(19) United States
(12) Patent Application Publication
(10) Pub. No.: US 2003/0002771 A1
(43) Pub. Date: Jan. 2, 2003

(54) Integrated optical amplifier

(75) Inventors: Julian Cheng, San Jose, CA (US); Long Yang, Union City, CA (US)

Correspondence Address: CHARLES E. WANDS, Allen Dyer Doppett Milbrath & Gilchrist PA, 1401 Citrus Center, 255 Orage Ave., P.O. Box 3791, Orlando, FL, 32802, US

(73) Assignee: JDS Uniphase Corporation, San Jose, CA (US)

(21) Appl. No.: 10/161,486

(22) Filed: May 31, 2002

Related U.S. Application Data
(60) Provisional application No. 60/294,569, filed on Jun. 1, 2001.

(51) Int. Cl. G02B 6/12; G02B 6/10

(52) U.S. Cl. 385/14; 385/129; 359/342

(57) ABSTRACT

A waveguide device for optical amplification and light amplification by stimulated emission radiation comprises an optical medium formed from a bulk glass. The optical medium is fused to a planar substrate to form a lower cladding. The bulk glass is subsequently thinned, patterned and coated with an upper cladding to form waveguide channels with sufficient mode confinement and mode field dimension compatible with direct coupling to optical fibers to achieve low insertion loss and a reduced polarization dependent loss, while obviating the need for critical fiber alignment using lensed or tapered fibers. The bulk glass is preferably an Er-doped or Er—Yb co-doped bulk glass, which when fused to quartz, or other low refractive index glass or cladding, provides a gain region less than about 5 cm long that is strongly index-guided to better confine the pump beam, and in the case of an amplifier, the signal beam.

### CROSS REFERENCE TO RELATED APPLICATIONS

The present application claims priority from provisional application serial number 60/294,569 filed on Jun. 1, 2001, which is incorporated herein by reference.

### BACKGROUND OF INVRENTION

The present invention relates to devices for optical amplification in the form of integrated optical waveguides.

Numerous methods have been proposed and developed for fabricating integrated optical waveguides. An integrated optical waveguide is the device having multiple waveguide channels formed on or within a monolithic substrate with provisions for detecting, and generating, modulating, filtering, attenuating or amplifying an optical signal.

While integrated optical devices offer great promise for reducing the size and cost of equivalent microscopic optical devices, there are numerous practical limitations. In all cases there must be provided means for efficiently coupling the optical output of the device to an optical communications system network comprising optical fiber waveguides. Additionally, the function of lenses and optical filters is readily duplicated in the planar orientation of integrated optical device without sacrificing performance over that available with conventional microscopic components.

The function of optical amplifiers has been particularly difficult to duplicate effectively in integrated optical devices, despite a long-standing need for lower-cost optical amplifiers than those fabricated by using lengths of Er doped fiber as the optical gain medium, that is the Er doped fiber amplifier (EDFA).

For example the anticipated need in metropolitan area optical network is for low cost optical amplifiers that can provide sufficient optical gain to compensate the optical losses that are experienced in a small but finite number of hops (typically 4 to 8) between SONET rings and in optical cross-connect switches. Conventional EDFA's based on single-mode Er-doped fibers can provide high optical gain (>30 dB) and a low noise figure, but their costs are not easily reduced to the low level (˜$1-2 K) that is required for Metro applications, which call for both high performance and low cost. The material cost is dominated by the cost of the Er doped fiber (typically 10-15 m in length for C-band and 40-100 m long for L-band) and that of the pump laser. Recently, other formats for the active gain medium have been used, including planar waveguides that are formed in Er or Er/Yb-doped glasses by the ion exchange technique (e.g., by Teem Photonics and MOEC), as well as Er/Yb-doped double-clad fibers (Kigre). These glasses have the advantage that a much higher doping level can be achieved than in a doped single-mode fiber (10¹⁸ to 10¹⁹/cm³ in an Er-doped fiber, compared to>10²⁰/cm³ for bulk glass), with the resulting possibility that a much shorter gain region can be used to achieve a smaller form factor. However, the index difference that is achieved is small, and the waveguide confinement is relatively weak, with the result that high pump power is necessary to achieve a sufficient optical power density for the desired optical gain. Moreover, because of the relatively shallow diffusion depth, the waveguide also suffers from a high insertion loss due to its mode mismatch to a single-mode fiber, in addition to polarization dependence.

Prior art consists of research on Er-doped and Er/Yb co-doped bulk glasses by Schott Glass Technologies, Inc. A large body of work on glass lasers is based on this material: D. L. Veasey, D. S. Funk, N. A. Sanford, J. S. Hayden, and M. Bendett, Appl. Phys. Lett., Vol. 74, 789-791, 1999; also in: Laser Focus World, 1999. , D. L. Veasy, et al.:“Yb/Er Codoped and Yb-Doped Waveguide Lasers in Phosphate Glass”, J. of Non-Crystalline Solids, Vol. 263, pp. 369-381, 2000 and optical amplifiers, for example D. Barbier, et al., “Amplifying Four Wavelength Combiner Based on Er/Yb Doped Waveguide Amplifiers and Integrated Splitters, IEEE Photonics Technol. Lett., Vol. 9, pp.315317, 1997. (e.g., Teem Photonics, Inc., and MOEC, Inc.) have been reported, in addition to the contract research performed by Kigre, Inc. in M. J. Myers, J. D. Myers, R. Wu, D. Rhonehouse: OFC 2001.[5]. S. D. Conzone, J. S. Hayden, D. S. Funk, A. Roshko, and D. L. Veasey: ” Hybrid Glass Substrates for Waveguide Device Manufacture“, Optics Letters, 2000. Most of these works are based on bulk glass layers (for lasers), specialty fibers, or waveguides produced by the K⁺-Na⁺ ion-exchange process.

However such devices suffer in performance as the aforementioned ion exchange process provides an insufficient refractive index contrast for efficient waveguide propagation, and additionally is not well mode-matched to single-mode optical fiber resulting high insertion loss and polarization dependent loss.

Additionally, prior art devices have required specially terminated optical fibers having either microscopic lenses or taper for low loss coupling of input and output signals. The alignment of these types of optical fiber to yield low insertion loss within low tolerances is a costly and critical step in the manufacturing process.

It is therefore a first object of the present invention to provide integrated optical devices for optical amplification comprising waveguides with a high refractive index contrast for efficient waveguide propagation within an optical gain medium.

Yet another object of the invention is to provide waveguide optical amplifiers that are mode-matched to a single-mode optical fiber

A further object of the present invention is to achieve low insertion loss and a reduced polarization dependence,

Yet another object of the invention is to eliminate the need for critical fiber alignment using lensed or tapered fibers.

A further object of the invention to provide a method of optically pumping such integrated optical amplifiers.

In summary, achieving the aforementioned objectives is intended to provide integrated optical waveguide amplifiers that provide relatively high amplification with relatively low pump power, as well as improved integrated optical lasers.

### SUMMARY OF INVENTION

In the present invention, the first object is achieved by fabricating an integrated optical device by fusing a substrate and an optical gain medium formed from a doped bulk glass composition, defining waveguiding routes in the optical gain medium, and then depositing at least an upper cladding layer of a lower refractive index over the optical gain medium to define waveguide channels for receiving a pump beam and transmitting an output beam.

Another object of the invention is achieved by fabricating the waveguide channels with sufficient refractive index contrast and dimensions to avoid polarization losses, and to have a propagation mode matching that of the interconnected optical fiber waveguide.

Yet another object of the invention is achieved by fabricating waveguide channels having both undoped region and doped region that act as the optical gain medium and configuring the pump beam input waveguide and the optical signal beam input waveguide to provide substantially exclusively common propagation within the optical gain medium.

Yet another object of the invention is achieved by fabricating the integrated optical device with optical filters to provide for multiple traverses of the optical beams through the waveguide channels containing the optical gain medium across the integrated optical device with minimum loss.

Yet another objective of the invention is achieved by fabricating discrete waveguide bars having the inventive waveguides structure and materials for subsequent assembly and construction onto a second substrate providing means for efficient interconnection with other integrated optical components as well as optical fiber waveguides.

An alternative application of the present invention is the fabrication of compact, high-power lasers emiting in the 1540-1560 nm band using the Er or Er/Yb doped glass waveguide geometry described herein. The only modification needed is to set up a resonance cavity by coating the facets with the appropriate high reflector back facet, and low reflector output coupler mirror coatings. This is an effective means for making compact high power glass lasers to replace the bulkier and more expensive Er-doped or Yb-doped fiber lasers.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-section view illustrating a first embodiment of the inventive integrated optical device.

FIG. 2 illustrates an alternative embodiment of the invention and that permits the utilization of substrates 210 having a higher refractive index than the optical gain medium and waveguide channel 220.

FIG. 3 illustrates through various cross-sections the steps in fabricating a first embodiment of the integrated optical device.

FIG. 4 illustrates through various cross-sections the steps in fabricating a second embodiment of the integrated optical device.

FIG. 5(a) illustrates the waveguide routing within an optical amplifier in plan view; (b) cross-section transverse to the direction of light propagation, and (c) cross-section through an optical port and parallel to the direction of light propagation.

FIG. 6 illustrates alternative embodiments for waveguide routing within an optical amplifier in plan view (a) and a schematic longitudinal cross-section (b) wherein the waveguide has a doped region for optical gain and an undoped region which allow for placement of input, output and optical pump ports on various sides of the device as well as multiple traverses across the integrated optical devices optical gain medium.

FIG. 7 illustrates alternative embodiments for waveguide routing within an optical amplifier in plan view (a) and a schematic longitudinal cross-section (b) wherein the reflective interference filters are positioned before the signal input and output to reflect the pump wavelength and transmit the signal wavelength.

FIG. 8 illustrates alternative embodiments for waveguide routing within an optical amplifier in plan view (a) and a schematic longitudinal cross-section (b) wherein the waveguide device includes placement of the input, output and optical pump ports on one side of the waveguide device.

FIG. 9 illustrates alternative embodiments for waveguide routing as shown in FIG. 8. in plan view (a) and a schematic longitudinal cross-section (b).

FIG. 10 illustrates composite device comprising a multiplicity of waveguide bars as (a) cross-section at optical port showing external connection to an optical fiber, (b) exploded view showing multiple waveguide bars and optical fibers aligned on a common substrate.

### DETAILED DESCRIPTION

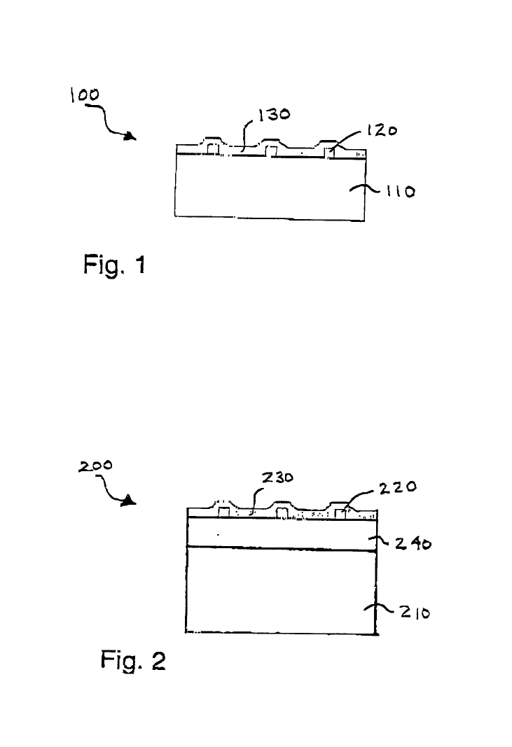

Turning now to FIG. 1, a first embodiment of the invention is illustrated as a schematic diagram showing a cross-section of the waveguide device 100. The waveguide device 100 comprises a planar substrate 110 of a first refractive index having disposed thereon an optical gain medium 120 in the form of rectangular channels that act as waveguides. These waveguide channels are formed from a bulk glass composition of a second refractive index, wherein the second refractive index is higher than the first refractive index. The rectangular channels 120 are surrounded by an outer cladding layer 130 having a refractive index lower than the second refractive index, such that light entering the waveguide channels 120 from a first edge of the device is confined to propagate within an optical path defined by the waveguide channel 120.

The waveguides channels are formed from a bulk glass composition comprising one or more dopant having multiple electron energy levels suitable for population inversion to enable light amplification of an incoming optical signal, or spontaneous emission.

Forming such an optical medium from a bulk glass composition provides several advantages over other fabrication techniques, which are exploited in the various embodiments of the invention, described in further detail below. Foremost however, by fabricating the waveguide channels from a bulk glass composition, optical transmission and amplification characteristics can be optimized to provide high performance active devices of relatively compact size that are better suited for further integration with optical waveguide components.

In a preferred embodiment the optical gain media is a phosphosilicate glass comprising erbium and ytterbium in a ratio of Er:Yb from about 1:1 to about 10:1, this range of composition providing for efficient coupling of excitation energy into the output signal of the device. Additionally, as optical device performance is diminished by propagation losses within the waveguide, coupling losses between the waveguide and other devices, as well as loss of optical energy in the cladding layer, the fabrication method disclosed herein enables particular configurations of the waveguide channels so as to reduce each of these potential loss mechanisms.

By fabricating the channel waveguides with a thickness of about 10 microns and an aspect ratio of about 0.5:1 to 1.5:1 the coupling loss to an optical fiber can be minimized through direct optical contact at the horizontal facet of the device, eliminating the need for critical fiber alignment or using lensed or tapered fibers.

In order to minimize the propagation losses within the waveguide the difference in refractive index between the optical medium and the cladding layer is preferably > about 0.010 so as to obtain sufficient mode confinement. Additionally, by forming the waveguide channels from a bulk glass composition, that is a glass formed by melting and then solidifying a homogenous molten composition, the internal transmission losses from absorption and scattering are minimized.

Typically, the phosphosilicate glass has a refractive index of 1.513 at 1.54 μm, and therefore a preferred substrate and upper cladding material is silica, which having a refractive index of 1.45, provides a substantial difference of refractive index, 0.063, for enhancing mode confinement. It should be noted that this difference is considerably larger than can be achieved by utilizing an ion-exchange process; these prior art methods provide a refractive index difference of only about 0.009 between the regions of low refractive index and a similar composition of phosphosilicate glass in the form of a monolithic slab.

Although the preferred substrate 110 in FIG. 1 is silica, FIG. 2 illustrates an alternative embodiment of the invention as a cross section of waveguide device 200 that permits the utilization of substrate 210 having a higher refractive index than the optical gain medium and waveguide channel 220. In this case a lower cladding layer 240 is disposed between the substrate and the bulk glass composition used to form waveguide channels 220, the lower cladding 240 having a lower refractive index than the optical gain medium.

In order to minimize the coupling losses at the interconnections with optical fibers the waveguide channels have physical dimensions and refractive index matched to the mode field dimensions of optical fibers. Accordingly, the waveguide channels preferably have a thickness from about 8 to 10 microns and a width of about 10 microns, thus forming a substantially squared channel cross-section to minimize polarization dependent losses.

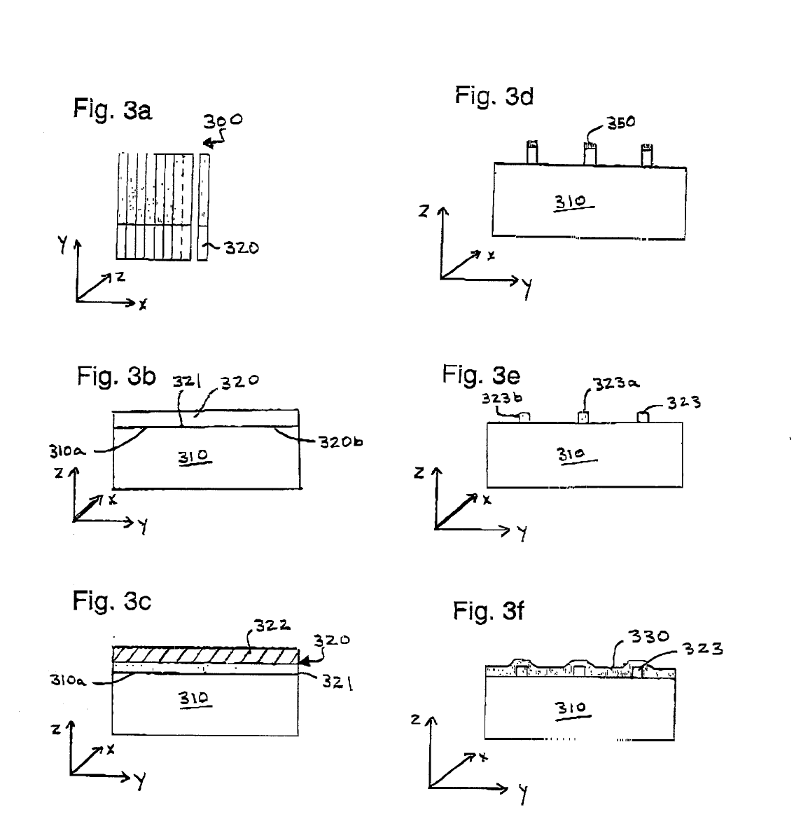

FIG. 3 illustrates the sequence of steps used to fabricate the embodiment of the invention described with respective FIGS. 1 and 2. In the first process step, FIG. 3(a), boule 300 of bulk optical glass having the desired dopant concentrations, purity and optical homogeneity are fabricating into wafers 320, having a thickness of about 1 mm thick, but preferably less than 500 microns thick. In the preferred embodiment using wire sawing or other techniques commonly deployed for glass fabrication. The dashed lines through boule 300 in FIG. 3(a) indicate the cutting direction to provide a multiplicity of wafers 320.

Optical glass for an optical gain medium is readily obtained as a bulk optical glass in the form of a boule from commercial vendors, such as Schott Glass of Duryea, Pa. For high gain waveguide amplifiers with low coupling losses to optical fiber the preferred optical gain medium is a phosphosilicate glass doped with high concentrations of Er and Yb (up to 10²⁰/cm³ and 10²¹/cm³, respectively) with dopant ratios ranging from 1:1 up to 10:1.

The glass wafer 320 must either be cleaned or polished in a further step in order to obtain a sufficiently smooth surface for optical contacting and binding to the substrate material 310 shown in FIG. 3(b).

Generally speaking, the lower surface 320b of glass wafer 320 is precision polished and cleaned in preparation for optical contacting with a similarly prepared upper surface 310a of substrate 310. In the next step, FIG. 3(b), the upper surface of substrate 310a and the lower surface of glass wafer 320b are optically contacted and then annealed in order to provide chemical bonding or otherwise sufficiently strong adhesion and permanent optical contact between their common interface 321. After optical contacting the structure shown in FIG. 3c is gradually heated to a temperature below the fusion temperature of the materials comprising the glass wafer 320 and substrate 310 and held at that temperature for sufficient time to permits atomic diffusion to occur to the extent necessary for forming strong adhesive bonds at the common interface 321. As the details of this process will depend on the chemical nature, composition and glass transition temperature of the glass wafer material 320 and similar characteristics of substrate 321 it may be advantageous in some cases to deposit intermediate layer onto either surface 310a or 320b by either a chemical process or a vapor deposition process to facilitate bonding or provide a lower optical cladding 240 as illustrated in FIG. 2. Further examples of suitable substrate combinations, methods of substrate preparation and wafer attachment by optical contacting and subsequent fusion are taught in a number of patents, for example U.S. Pat. No. 5,408,566; U.S. Pat. No. 5,485,540; U.S. Pat. No. 5,846,638; and U.S. Pat. No. 5,441,803, which are incorporated herein by reference.

In the next steps in the process, which need not necessarily be carried out in the sequence described, the final dimensions and of the waveguide channels are defined. This is illustrated in FIG. 3c in which the shaded area 322 of now bonded glass wafer 320 is removed to reduce this glass layer to substantially the same thickness as the desired waveguides while bonded to the substrate 310. The simplest and preferred method of reducing the thickness is polishing, since it also provides a method of removing any roughness or defects formed in the upper surface of the waveguide channels that arises from the sectioning operation previously described. Preferably the precision polishing process results in a layer having a thickness of 8-10 μm, leaving a surface substantially free of roughness that would cause optical losses through light scattering.

As this fusion process may be performed at high temperature and under pressure to facilitate diffusion at interface 321, the substrate is preferably a phosphosilicate glass having substantially the same thermo mechanical properties as the bulk optical glass, however the substrate may also consist of silica or another glass composition having a low refractive index.

As the preferred waveguide channel width is about 10 microns, it will be apparent to those skilled in the art of micro fabrication of optical or semiconductor devices that numerous photolithographic methods and etching processes can be utilized to remove those sections of the glass wafer of outside of the desired waveguides channels. The photolithographic patterning, FIG. 3(d) and etching results in long, narrow strips 323, shown in FIG. 3(e) that are approximately 8 to 10 microns wide (or curved waveguides if necessary). These strips 323 may be further etched chemically or dry-etched in a plasma etcher to provide substantially horizontal and linear sidewalls 323b.

Alternatively, depending on the method of defining the waveguide channels and removing any excess glass wafer material, it may be necessary in additional steps to reflow the edge pattern to improve the surface morphology of the upper surface 323a and/or side walls 323b. After removing the etch mask 350 in FIG. 3(d), the sample can be heated in a furnace to a temperature above the glass transition temperature of the phosphosilicate glass in order to allow surface reflow to smooth out the surface roughness and to reduce the optical scattering loss.

In the next step in the process, shown as completed in FIG. 3(f) an upper cladding layer 330 is deposited on the upper surface 323a and side walls 323b of strips 323 such that they function as optical waveguide channels. Depending on the deposition process, this upper cladding layer 330 comprises a material having a lower refractive index than the optical gain material that comprises waveguide channels 323. This cladding layer is preferably silica (SiO₂) as it has a low refractive index, about 1.45, but may optionally comprise a mixture of inorganic materials or organic materials. The cladding layer 330 preferably has a thickness of about 10 microns.

This thick cladding layer may be deposited over the entire substrate to also cover the regions of the upper surface of substrate 310 that were previously exposed in the removal of excess portions of glass wafer to define waveguide channels. This is illustrated in FIG. 3(f) as waveguide channels are entirely embedded within low-index cladding material. For applying the thick cladding layer on the active waveguiding layer 323 several techniques can be used. A method that is particularly suitable for use in the present invention is RF sputtering. This technique is known per se, for which reason it will be discussed here only briefly. In a vacuum chamber, a target having a suitable composition to be deposited with regard to the desired composition of the active guiding layer, is arranged opposite a substrate. In the vacuum chamber, argon and oxygen are introduced, such that the pressure in the vacuum chamber is in the range of about 0.3 to 5 Pa. RF power is applied to the target. Argon atoms hit the target, such that atoms and/or molecules of the target are emitted from the target and deposited on the substrate. This process is continued until the deposited layer has sufficient thickness.

Further, as the aforementioned glass compositions only act as an efficient optical gain medium when optically pumped (to create an inverted population of excited ions in higher energy level) without pumping, the dopant ions strongly absorb light at the pump and signal wavelengths. Thus the optical signal must be routed from the optical port on the waveguide device to an activated region of the optical gain media before an inactivated region of the same gain medium attenuates it. Likewise, the pump beam energy must be efficiently distributed within the same region to obtain the high gains at the lowest pump power.

Accordingly, further aspects of the invention are described in various embodiments that illustrate methods of routing and coupling optical signal within homogenous and heterogeneous waveguides.

A heterogeneous waveguide comprises one or more channel waveguides having regions or segments of different waveguide mediums. Specifically the waveguide channel has a limited region or segment comprising the optical gain medium adjacent to or in optical communication with another region or segment comprising a substantially non-attenuating optical glass. The channel waveguides are configured such that the coupling of the pump optical beam and the signal optical beam occurs in the non-attenuating optical glass. The interface between these two glass regions in a waveguide channel may be discrete, but is preferably stepped, in the fashion of an anti-reflection interference filter, gradual or graded or has other features to prevent signal loss and back reflection from an optical impedance mismatch if the refractive index of the two optical mediums are different. Therefore the discrete interface that is illustrated as transverse to the direction of propagation, is preferably formed at a slight angular offset from a perpendicular reference plane.

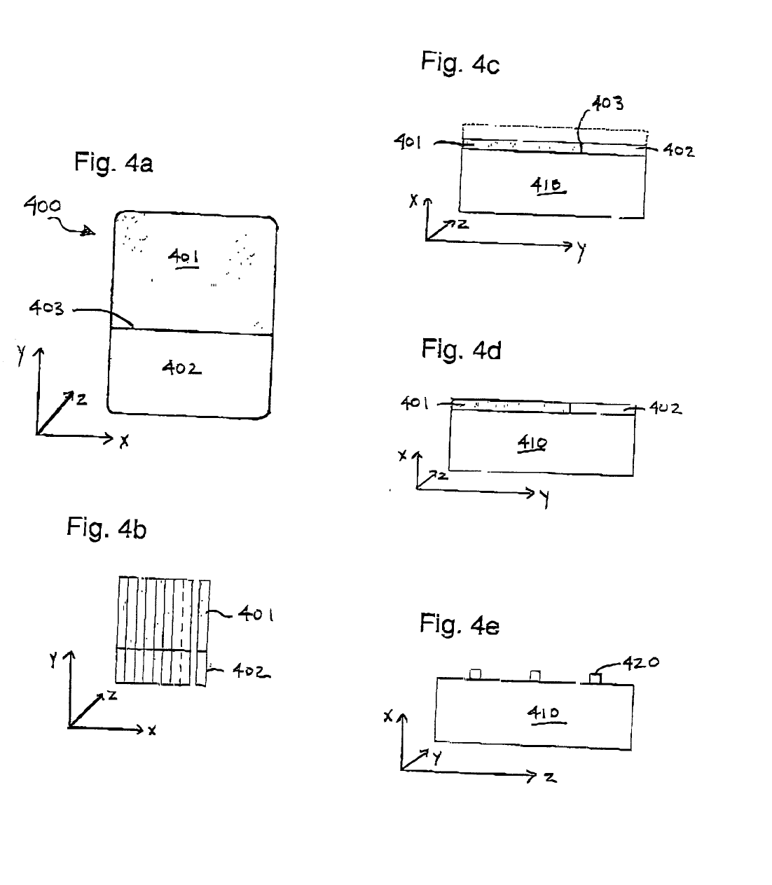

The fabrication of such heterogeneous devices is described with respect to Cartesian coordinates having orthogonal axis x, y and z in FIG. 4 (a) through 4 (e), supra. It will be recognized by one of ordinary skill in the art of optics that the general method described is applicable to conventional methods of minimizing optical impendence mismatched not specifically disclosed herein.

The direction of light propagation within the optical medium in the fabricated device formed from boule 400 is parallel to the y-axis. FIG. 4a shows composite boule of bulk glass 400 comprising a first layer 401 of the optical glass doped with rare earth elements or other materials to form an optical gain medium, and a second layer 402 of optical glass. This second layer 402 is preferably undoped but otherwise the same composition as the other optical glass so as to form a substantially non-attenuating optical medium for wave guiding, but without optical amplification. The first layer 401 has a thickness corresponding to at least the length of the waveguide segment comprising the optical gain medium, whereas the second layer has a thickness corresponding to at least the length of the waveguide segment comprising the undoped optical glass. Thus in FIG. 4(b) a glass wafer is sectioned from composite boule 400 along the dashed lines parallel to the plane of the paper, each such wafer will contain corresponding portions of the first and second layer's of the respective doped and undoped optical glass, which upon optical contacting and bonding will be disposed transverse to the substrate plane in FIG. 4(c) and 4(d), as interface 403 in waveguide 420 formed on substrate 410. FIG. 4(e) illustrates waveguide channels 420 in cross-section transverse to the direction of light propagation such that interface 403 is disposed parallel to the plane of the paper. The waveguide geometry also makes it easy to monolithically integrate a waveguide multiplexer to combine the power outputs of multiple pump laser sources.

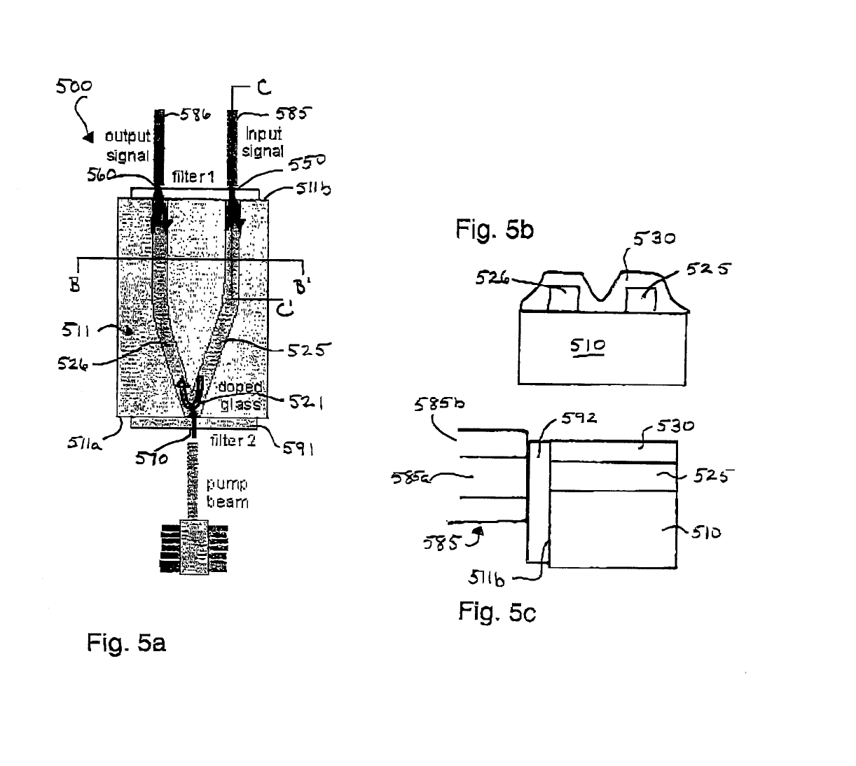

In yet another embodiment of the invention, illustrated schematically in FIG. 5(a) and 5(b), an integrated optical device having a homogenous waveguide media efficiently combines the input and pump optical signals to the amplifying channel waveguide. The optical amplifier 500 comprises a waveguide device 511 having a first edge 511a wherein the input waveguide segment 525 and output waveguide segment 526 terminates at pump beam input port 570.

FIG. 5(b) is a cross-sectional schematic of waveguide device 511 taken at segment B-B′ in FIG. 5(a) showing cross-sections of input waveguide segment 525 and output waveguide segment 526 disposed on substrate 510 and otherwise surrounded by upper cladding layer 530.

The other terminal ends of waveguide segment 525 and 526 are disposed on the second edge 511b of waveguide device 511, thus defining an output optical port 560 and the input optical port 550.

FIG. 5(c) is a cross-sectional schematic of waveguide device 511 taken at section C-C′ in FIG. 5(a) illustrating the placement of optical fiber 585 at input optical port 550 wherein an optical filter 592 is disposed on the side 511b of waveguide device 511. Optical Fiber 585 has a core 585a and cladding layer 585b surrounding core 585a.

Optical filter 592 reflects wavelengths corresponding to the optical pump beam output while transmitting signal wavelengths from optical fiber 585 and to optical fiber 586. Optical filter 591 however provides the complimentary wavelength discrimination to optical filter 592, reflecting the optical signal wavelengths to direct the optical beam arriving from optical input port 550 toward the optical output port 560 in channel waveguide 526, while transmitting optical pump beam wavelengths such that the pump beam is split between channel waveguides 525 and 526.

In amplifier 500 the pump optical beam enters a homogenous wave guiding optical medium 521 at a pump optical port 570 and is immediately split into two channel waveguides 525, 526 to distribute the pump beam energy over a broader area of the optical gain medium to minimize gain nonuniformity. As the density of inverted population states decreases with distance from the pump beam input port because of the strong absorption of the optical gain medium, the reflection of the optical pump beam by optical filter 592 in the reverse direction in each of the channel waveguides 525 and 526 provides a more uniform spatial distribution of population inverted dopants along the length of each channel. The optimum length, L, is dependent on pump beam wavelengths, the absorption cross-section for these wavelengths in the optical gain medium among other factors to simultaneously optimize the gain and signal to noise ratio.

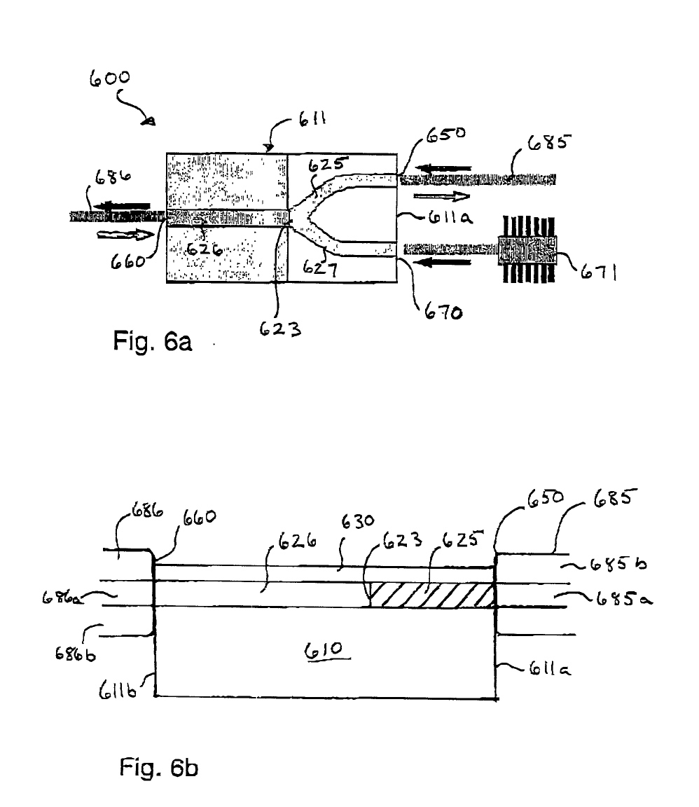

A doped glass amplifier in accordance with the present invention is optically pumped by a semiconductor laser, which can emit in either the 1480 nm (for Er) or the 980 nm (for Yb) wavelength range. The amplifier design must combine the signal and pump beams using the single mode waveguide geometry. This can be done using a number of different configurations that provide alternatively unidirectional or bi-directional pumping. FIGS. 6, 7, 8 and 9 illustrate embodiments of heterogeneous waveguide devices wherein the optical coupling of the input signal and pump optical beams occurs in a first region comprising a substantially non-attenuating, undoped waveguide medium.

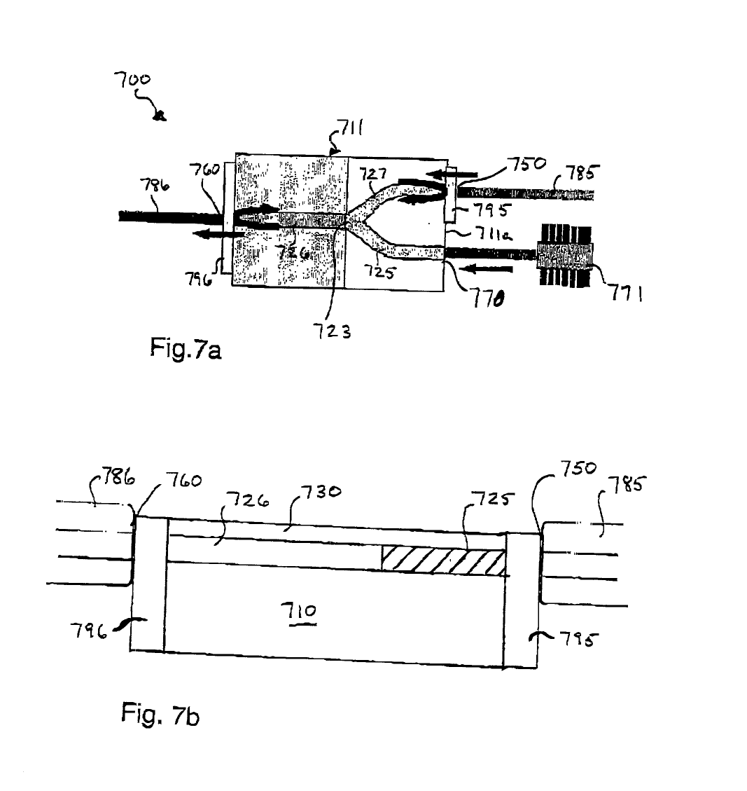

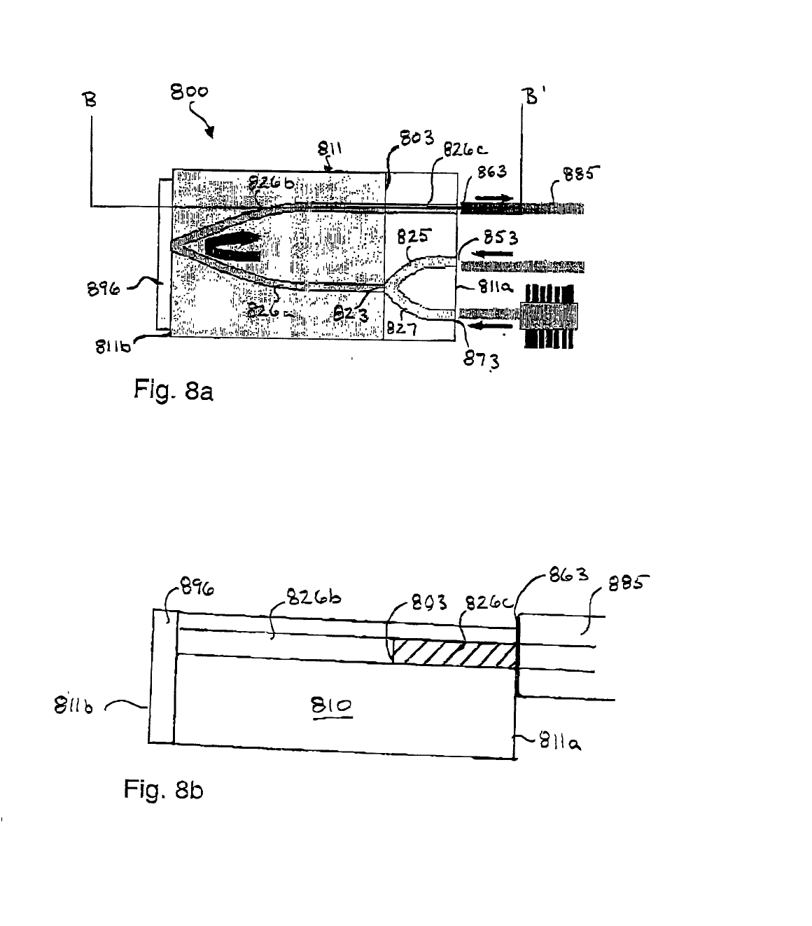

FIG. 6a, 7a, 8a, and 9a are plan views schematically illustrating alternative routing configurations of waveguide channels segments within optical amplifier device 600, 700, 800 and 900 respectively. FIGS. 6b, 7b, 8b and 9b are elevations showing a cross-section of the channel waveguide through the optical gain medium as well as the substantially non-attenuating waveguide medium. These elevations also illustrate the alignment of one or more optical fibers at an optical port on a horizontal facet of the device in relationship to the optional optical filters present in FIGS. 7 and 8.

At least one of the waveguide channels in each of FIGS. 6, 7, 8, or 9 passes through a substantially nonattenuating waveguide medium, such as an undoped optical glass having substantially the same composition as the optical gain medium.

FIG. 6(a) illustrates an embodiment of the invention in which optical port 670, for receiving a pump optical beam from pump laser 671, and input optical port 650 are both disposed on a first side 611a of waveguide device 611.Waveguide channel 627 is a single segment, originating at the pump beam port 670 on the first side 611a of waveguide device 611. Waveguide channel 625 is also a single segment originating at the signal input port 650 on this first side 611a of waveguide device 611. Channel waveguides 625 and 627 are formed of the substantially non-attenuating wave-guiding medium and co-terminate as an optical coupling at interface 623 with the optical gain medium of third channel waveguide 626. Third channel waveguide 626 extends to output optical port 660. The interface 623 between the optical gain medium and the substantially non-attenuating waveguide medium is preferably fabricated as described with respect to FIG. 4, as this method is readily adapted to produce an interfacial region with minimum optical impedance.

FIG. 6(b) is a cross-sectional schematic of optical amplifier 600 of FIG. 6(a) illustrating the placement of optical fiber 685 and 686 at optical ports at side 611a and 611b located on the corresponding end facets of waveguide device 611. The cross-section also illustrates the juxtaposition of hetero-interface 623.

Figure 7a illustrates an embodiment of the invention in which optical port 770, for receiving an optical beam from pump laser 771, and input optical port 750 are both disposed on a first side 711a of waveguide device 711. Waveguide channel 725 is a single segment, originating at the pump beam port 760 on the first side 711a of waveguide device 711. Waveguide channel 727 is also a single segment originating at the signal input port 750 on this first side 711a of waveguide device 711. Channel waveguides 725 and 727 are formed of the undoped wave-guiding medium and co-terminate as an optical coupling at interface 723 with the optical gain medium of third channel waveguide 726.

Figure 7b is a cross-sectional schematic of waveguide device 711 taken at section A-A′″ in FIG. 7(a) illustrating the placement of optical fiber 785 at input optical port 750 wherein an optical filter 795 is disposed on the side 711a of waveguide device 511 and a further optical filter 796 is disposed on the opposite side 711b in order to provide bi-directional pumping. Optical filters 795 and 796 are reflective at the pump wavelength and transmissive at the signal wavelength. The result of this design is to reduce the length of the doped glass amplifier. A double pass geometry halves the total length of the active glass fro greater compactness. This can be as short as 2 cm.

FIG. 8 illustrates yet another embodiment of the invention in which optical ports for the pump beam 873, input signal 853 and output signal 863 are all disposed on a first side 811a of waveguide device 811. Waveguide channel 827 is a single segment, originating at the pump beam port 873 on the first edge 811a of waveguide device 811. Waveguide channel 825 is also a single segment originating at the signal input port 853 on this first edge 811a of waveguide device 811.

Channel waveguides 825 and 827 are formed of the substantially non-attenuating wave-guiding medium and coterminate as an optical coupling at interface 823 with the optical gain medium of third channel waveguide 826.

Channel waveguide 826 comprises the optical gain medium in 2 of 3 segments: (i) a first segment 826a that extends from the interconnection point at interface 823 to the opposite or second edge 811b of the waveguide device 811, (ii) a second segment 826b that extends from the second edge 811b back to interface 623, and (iii) a third segment 826c extending from interface 803 to the output port 863, which comprises the substantially non-attenuating wave guiding medium.

An optical filter 896 is disposed on the second side 811b of the waveguide device 811 to reflect co-propagating incident optical signal and pump beams entering channel waveguide 826 at interface 823 such that they enter channel waveguide segment 826c and propagate toward output port 863.

FIG. 8(b) is a schematic representation illustrating a cross-sectional schematic of a waveguide device 811 in optical amplifier 800 taken at segment B-B′ in FIG. 8(a) to reveal the interface 803 of the optical coupling at the co-terminus of channel waveguide 826c and the optical gain medium of the channel waveguide segment 826b.

Additionally, FIG. 8(b) illustrates the direct connection of optical fiber 885 at output 863 optical ports respectively. Although optical filter 896 is illustrated as disposed on the entire surface of 811b, this is not intended as the sole or limiting embodiment, as a fiber Bragg grating can be formed within a common channel waveguide to provide the same function. Additionally, the optical filter can be a discrete device or, in other embodiments can be provided by fabrication directly on the edge of the substrate 810.

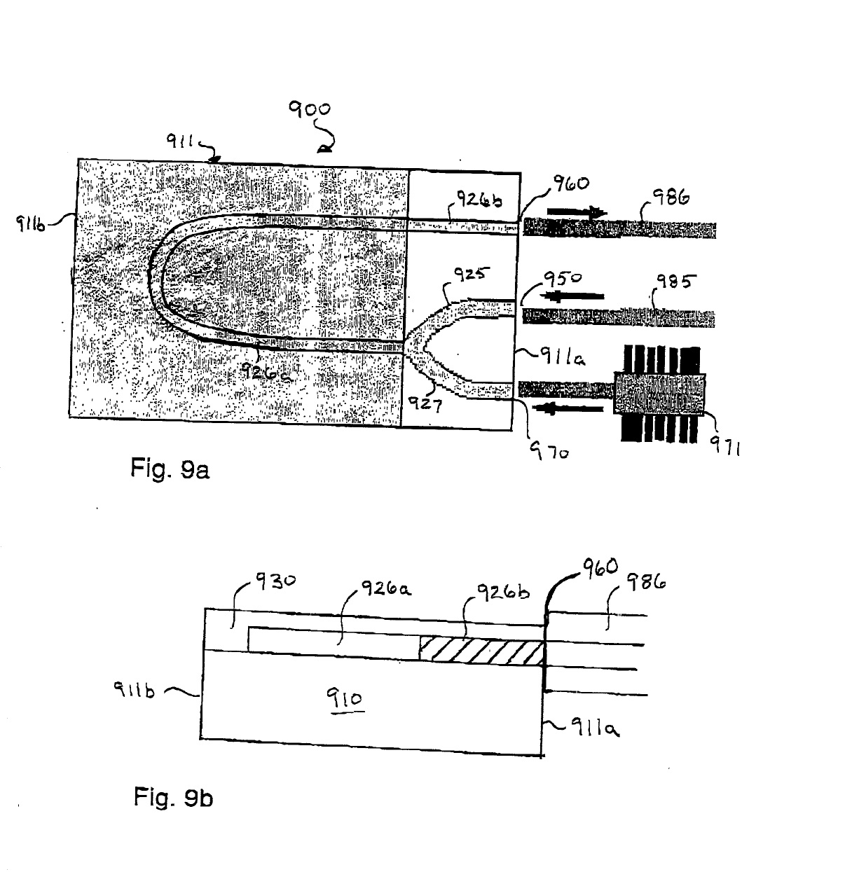

FIG. 9 schematically illustrates yet another embodiment of the invention in which optical amplifier 900 comprises a waveguide device 911 having a heterogeneous wave-guiding medium. Optical pump and signal beams are combined in the non-attenuating wave-guiding medium in waveguide channels 925 and 927 as described with respect to FIG. 8. However, the double pass through the optical gain medium of channel waveguide segment 926 is achieved by providing a loop segment 926a. While the loop segment 926a may limit the minimum width, W, of the device to a larger size than the device in FIG. 8, the configuration also avoids increasing the length to fully utilize the optical gain medium. Further, this design does not require the placement of optical filters at the device edge 911b.

Optical filters previously described with reference to FIGS. 5, 7 and 8, are preferably multi-layer interference filters (MLIF's) deposited directly onto the polished facets of the waveguide device. Such optical interference filters are advantageously deposited on these facets after the glass wafer is bonded to the substrate, thinned and photolithographic patterning of the waveguide channels is performed, eg. after step f shown in FIG. 3. This sequence improves the manufacturing efficiency by grouping together a large number of waveguide assemblies during the optical filter deposition process. However it will be recognized by one of ordinary skill in the art that in some instances fiber Bragg gratings (FBG's) may be substituted for MLIF's, and as such would be fabricated within either the optical gain waveguide medium, or in the case of a heterogeneous waveguide device, a portion of substantially non-attenuating waveguide medium.

Additionally, other optical filters may advantageously be provided or substituted for optical filters in any of FIGS. 5 through 9 inclusive. For example gain flattening filters that selectively attenuate the amplified optical signal (to compensate for any wavelength dependent gain during optical amplification) might be disposed at the output ports of any of these devices.

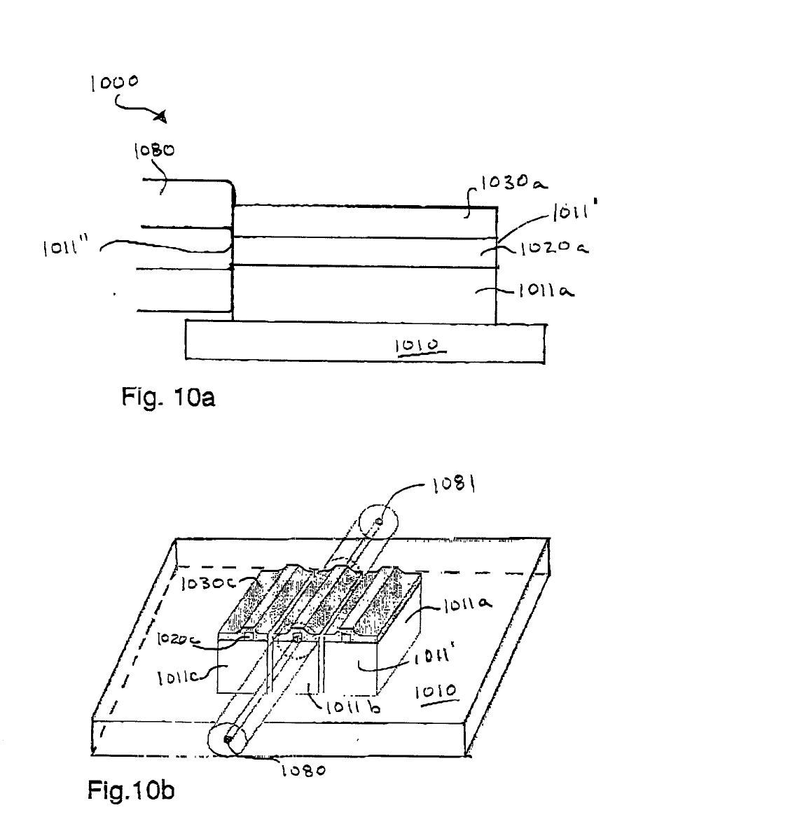

In yet other embodiments of the invention the fundamental fabrication method used to produce the aforementioned embodiments are exploited to couple various optical waveguide components on a single substrate to form a composite waveguide device. Such composite device 1000 may comprise waveguide arrays as well as contain multiple active or passive components. FIG. 10a is a cross section of such a device while FIG. 10b is an exploded view, showing connection of optical fiber 1080 to individual waveguide bars 1011a, b or c on such a device. The waveguide bars 1011 might for example be fabricated from the waveguide array in FIG. 1 by further division into a multiplicity of bars having roughly equal width and length in the plane of the substrate. Such waveguide bars may contain multiple channel waveguides and optical couplings between channels waveguides, and can have a heterogeneous or homogenous waveguiding medium.

The end facets 1011′ and 1011″ of these waveguide bars can be polished and coated with multi-layer interference optical filters or combined with other devices on a second substrate. The second substrate 1010 may contain additional features (not illustrated) for aligning as well as securing the optical fiber 1080 and 1081 shown in FIG. 10, as well as for aligning and joining other waveguide devices in optical communication by direct contact at the optical ports of the waveguide bars, substituting for optical fiber 1081. Such other devices may include but are not limited to other optical components useful in WDM communications systems, for example gain flattening filters, optical tap filters, optical fiber lasers, waveguide lasers, arrayed waveguide gratings, and the like.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

What is claimed is:

1. An optical device comprising:
a) a substrate
b) an optical gain medium comprising a doped bulk glass composition supported by said substrate
c) at least an upper cladding layer deposited over the optical gain medium to define a waveguiding region within the optical gain medium for receiving a pump beam and transmitting an output beam.

2. An optical amplifier device comprising:
d) a substrate
e) an optical gain medium comprising a doped bulk glass composition supported by said substrate,
f) at least an upper cladding layer deposited over the optical gain medium to define a waveguiding region within the optical gain medium for mixing a pump beam input signal and conveying an amplified ouput signal.

3. An optical amplifier device comprising:
g) a substrate
h) an optical gain medium comprising a doped bulk glass composition supported by said substrate,
i) at least an upper cladding layer deposited over the optical gain medium to define a waveguiding region within the optical gain medium for mixing a pump beam input signal and conveying an amplified output signal
wherein the difference between the refractive index of the cladding is greater than about 0.009.

4. An optical amplifier device according to claim 3 wherein the optical gain medium has a thickness of at least 8 microns.

5. An optical amplifier device according to claim 4 wherein the waveguiding medium has an aspect ratio of height to width of about 0.5:1 to 1.5:1.

6. An optical amplifier device according to claim 3 further comprising a channel waveguide of an undoped waveguiding medium in optical communication with the optical gain medium.

7. An optical amplifier device according to claim 3 wherein the interface between the undoped waveguiding medium and the optical gain medium further comprises means for reducing the optical impedance.

8. An optical amplifier device according to claim 3 wherein the interface between the undoped waveguiding medium and the optical gain medium further is a graded composition.

9. An optical amplifier device according to claim 3 wherein the interface between the undoped waveguiding medium and the optical gain medium further comprises additional layers to provide step changes in refractive index.

10. An optical amplifier device according to claim 3 wherein the interface between the undoped waveguiding medium and the optical gain medium further is not perpendicular to the direction of light propagation at least one of the waveguide segment adjacent to the interface.

11. A method of fabricating an active optical device, the method comprising:
j) forming a first planar surface in a substrate material,
k) forming a second planar surface on optical medium in the form of a bulk glass,
l) optical contacting the first and second planar surface,
m) fusing the first and second planar surface,
n) reducing the thickness of the active optical medium to about 10 microns,
o) defining a channel waveguide route within the about 10 micron thick optical media,
p) removing optical medium surrounding the channel waveguide route,
q) forming an upper cladding layer on top of the remaining portions of the optical media such that the refractive index of the upper cladding and the optical medium differ by at least 0.008.

12. A method of fabricating an optical amplifier
r) forming a planar surface in a first substrate material
s) forming a planar surface in a second substrate material
t) forming a channel waveguide region on the first substrate by:
i) fusing a optical gain medium derived bulk optical glass to the first planar surface
ii) patterning waveguide channels within the optical gain medium
iii) depositing an upper cladding layer on the waveguide channels
iv) sectioning the first substrate into bars containing one or more waveguide channels
u) disposing the bar derived from the first substrate on the second substrate in optical communication with an optical signal source selected from the group consisting of an optical fiber, an optical fiber laser, a waveguide laser, and an arrayed waveguide.

13. A waveguide optical amplifier comprising:
v) a planar substrate,
w) a first waveguide segment having an upper cladding layer terminating at a pump port proximate the edge of said planar substrate,
x) a second waveguide segment having an upper cladding layer terminating at an input signal port proximate the edge of said planar substrate,
y) a third waveguide segment having an upper cladding layer terminating at an output signal port proximate the edge of said planar substrate,
z) an optical filter disposed at the output signal port for reflecting the optical pump source.

14. A waveguide optical amplifier according to claim 13 wherein the optical filter is a multilayer interference filter.

15. A waveguide optical amplifier according to claim 13 wherein the multilayer interference filter is selected from
the group consisting of a gain flattening filters, a bandpass filter, a broadband reflective filter.

16. A method of amplifying an optical signal, the method comprising;
aa) coupling a first optical fiber carrying an input signal at a first port at the first terminal end of a first waveguide segment formed on a planar substrate,
bb) coupling a second optical fiber for transmitting an amplified output signal at a second port at the first terminal end of a second waveguide segment formed on the planar substrate wherein
i) the first terminal ends of the first and second waveguide arms are proximate the edge of the substrate,
ii) the second terminal end of the first waveguide segment is optically coupled to the second terminal end of the second waveguide segment, and
iii) at least one of the first and second waveguide segments traverse a waveguide region comprising rare earth dopants dispersed in the waveguide material to form an optical gain medium,
cc) coupling an optical pump having a first wavelength emission range at a third port proximate the edge of said substrate, wherein the optical pump is optically coupled to the second waveguide segment,
dd) exciting the optical pump source to illuminate at least the second waveguide segment,
ee) reflecting the optical pump source radiation by a first optical filter disposed between the second port and the second optical fiber pump beam twice passes through the portion of the optical amplification medium traversed by the input signal.

17. An integrated optical device comprising:
ff) a first substrate
gg) one or more optical waveguide devices supported by said substrate, at least one of said waveguiding devices comprising,
i) a second substrate,
ii) an optical gain medium comprising a doped bulk glass composition supported by said second substrate,
iii) at least an upper cladding layer deposited over the optical gain medium to define a waveguiding region within the optical gain medium for receiving a pump beam and transmitting an output beam.

18. The integrated optical device according to claim 17 further comprising and optical fiber having a core region in optical communication with the optical gain medium via an optical port for on the horizontal facet of said optical waveguide device.

19. The integrated optical device according to claim 17 wherein said optical waveguide device comprises two or more waveguide channels.

20. The integrated optical device according to claim 17 wherein said optical waveguide device comprises an optical coupling between two or more waveguide channels formed at the interface between the optical gain medium and an undoped optical medium.

21. The integrated optical device according to claim 17 further comprising an optical waveguide device selected from the group consisting of gain flattening filters, optical tap filters, optical fiber lasers, waveguide lasers and an arrayed waveguide grating.

22. The integrated optical device according to claim 21 wherein an optical filter is formed on the end facet of said optical waveguide device.
